(19) United States
(12) Patent Application Publication
(10) Pub. No.: US 2008/0025353 A1
(43) Pub. Date: Jan. 31, 2008

(54) Wavelength locked diode-laser bar

(76) Inventors: Sergei V. Govorkov, Los Altos, CA (US); Luis A. Spinelli, Sunnyvale, CA (US)

Correspondence Address: STALLMAN & POLLOCK LLP, 353 SACRAMENTO STREET, SUITE 2200, SAN FRANCISCO, CA, 94111, US

(21) Appl. No.: 11/494,896

(22) Filed: Jul. 28, 2006

(51) Int. Cl. H01S 3/13; H01S 3/08

(52) U.S. Cl. 372/29.022; 372/107

(57) ABSTRACT

A wavelength-locking arrangement for a diode-laser bar includes a cylindrical fast-axis collimating lens and a fast-axis corner reflector. An optical filter is located between the cylindrical lens and the corner reflector for defining the locked wavelength. The corner reflector provides that radiation emitted by each of the diode-lasers and collimated by the cylindrical lens is reflected back to the cylindrical lens and is focused by the cylindrical lens back into the diode-laser from which the radiation was emitted, independent of the fast-axis alignment of the diode-laser with the cylindrical lens.

### TECHNICAL FIELD OF THE INVENTION

The present invention relates in general to wavelength locking of diode-lasers. The invention relates in particular to wavelength locking a plurality of diode-laser emitters in a diode-laser bar.

### DISCUSSION OF BACKGROUND ART

Diode-lasers characteristically have a gain bandwidth that is about 5% of the nominal emitting wavelength or peak-gain wavelength of active layer materials of the diode-lasers. By way of example, the FWHM gain-bandwidth at a peak wavelength of about 800 nanometers (nm) would be about 40 nm. In addition, production techniques for diode-lasers are such that, in any batch of diode-lasers from a single growth, the peak-gain wavelength of individual diode-lasers can vary within about 5% of an average peak-gain wavelength for the batch.

The emitting wavelength of a single diode-laser can be locked at a desired wavelength (narrow range of wavelengths) within the gain-bandwidth by spectrally isolating a, narrow band of wavelengths from the diode-laser output and reflecting (feeding back) a percentage of the radiation in the narrow band of wavelengths back into the diode-laser. This selective feedback can be accomplished using a wavelength selective device such as a grating or an interference filter in conjunction with a full or partial reflector. Such devices typically require that radiation incident thereon is collimated in order to select the narrowest possible band of wavelengths from the device.

One diode-laser application that benefits from such wavelength locking is diode-laser pumping of solid state lasers. By way of example, an optimum pump wavelength for neodymium doped YAG (Nd:YAG) is about 808 nm which corresponds to an absorption band of the Nd:YAG having a bandwidth of only about 1 nanometers. If an Nd:YAG laser, or any other solid state-laser, is required to have an output power in the tens of Watts (W) or more, the required pump-power is more than can be supplied by a single diode-laser, and is usually supplied by an array of individual emitters in a diode-laser bar.

A diode-laser (edge-emitting semiconductor laser) bar usually includes a plurality of individual diode-lasers (emitters) distributed along a “bar” comprising a plurality of semiconductor layers epitaxially grown on an electrically conductive semiconductor substrate. Such a bar usually has a length of about 10 millimeters (mm), a width of between about 1 mm and 1.5 mm, and a thickness of between about 100 micrometers (μm) and 300 μm. The emitters (diode-lasers) of the bar are formed in the epitaxial layers.

In a diode-laser bar configured to deliver near infrared radiation with a power of about 1 Watt (W) per emitter or more, the width of the emitters is typically between about 50 μm and 200 μm. Usually, the wider the emitter the higher the power output of an individual emitter. The number of emitters in a bar is determined by the length of the bar, the width of the emitters, and the spacing therebetween. Twenty emitters per bar is not an uncommon number of emitters per bar.

The emitters of a diode-laser bar ideally would be aligned with the slow-axes of the emitters exactly collinear. Even with the most careful manufacturing techniques, however, the emitting apertures are usually gradually misaligned along the length of the bar with a height difference in the fast-axis of a few microns between end ones of the apertures and a central one of the apertures. This misalignment is due to stresses developed in the epitaxial-layer growing process and is whimsically termed “smile” by practitioners of the art. Smile makes fast-axis collimation of beams from all emitters with a single cylindrical lens element (a collimation method preferred by practitioners of the art) difficult for reasons discussed below with reference to FIG. 1.

FIG. 1 schematically illustrates a diode-laser bar 20 including seven emitters 22A-G. Relative dimensions of the bar have been exaggerated for convenience of description. In FIG. 2 the fast-axis of the emitters (and the bar) is designated the Y-axis, the slow-axis is designated the X-axis (perpendicular to the Y-axis) and the propagation-axis is designated the Z-axis, perpendicular to both the X- and Y-axes. The extent of the smile of the bar is the distance S between the emitter 22D that has the lowest Y-axis height and emitters 22A and 22G that have the highest Y-axis height. Beams from the emitters will propagate in a general direction of propagation parallel to the Z-axis in both the Y-Z and X-Z planes.

FIG. 2 schematically illustrates a situation wherein a cylindrical lens 26 having a length extending completely along the diode-laser bar is used to collimate output beams of the emitters in the fast-axis (Y-axis). Clearly, optic axis 28 of such a lens 26 can only be exactly aligned with the Z-axis of at most two of the emitters. In FIG. 2 it is assumed optic axis 28 of lens 26 is aligned with the Z-axes of emitters 22B and 22F in diode-laser bar 21 of FIG. 1. Rays emitted by these emitters are represented by solid lines 30. The collimated rays 30 (designated 30C) propagate parallel to the Z-axis of the diode-laser bar because of this precise alignment of the optic axis of the lens with the Z-axis of the emitters. A mirror 32 having a plane reflecting surface 34 perpendicular to the Z-axis will reflect rays 30C, normally incident on surface 34, back along the incident path of the rays and the rays will be focused by lens 26 back into emitters 22B and 22F.

Rays emitted by emitter 22D are represented by dashed lines 40. These rays will be collimated by lens 26 but the collimated rays 40 will propagate at an angle to the Z-axis in the Y-Z plane (while still being parallel to the Z-axis in the X-Z plane). Outbound rays 40 are designated rays 40_{OUT}. These rays will be incident non-normally on surface 34 and will be reflected from the surface at an angle equal and opposite to the incidence angle. These reflected rays are designated 40_{BACK} and are focused by lens 26 in the front plane of the diode-laser bar in a position 42 at the same height above optic axis 28 as emitter 22D is below optic axis 28. Diode-laser emitters typically have an emitting aperture only between about 1 μm and 2 μm high. Because of this, at most practical distances for a feedback mirror to be located from a collimating lens, one or two micrometers misalignment of an emitting-aperture with the optic axis of the fast-axis collimating lens would result in no reflected light from that emitter being focused back into the emitter.

In theory at least, a separate fast-axis collimating lens could be provided for each emitter in a diode-laser bar so the optic axis of the lens could be precisely aligned with the Z-axis of the emitter with which the lens is associated. This, of course, would be a very complex and expensive undertaking that could make the cost of a diode-pumped solid-state laser unacceptably high. There is a need for a reflective feedback for a diode-laser bar that is effective if only a single elongated fast-axis collimating lens is used to fast-axis collimate the output beams from the diode-laser bar.

### SUMMARY OF THE INVENTION

The present invention is directed to wavelength-locking output radiation from a diode-laser array or diode-laser bar including a plurality of individual diode-lasers or emitters. In one aspect, apparatus in accordance with the present invention comprises a plurality of diode-lasers each thereof having a gain-bandwidth, a fast-axis, and a slow-axis. The diode-lasers are arranged to emit laser radiation generally along a propagation-axis perpendicular to the fast- and slow-axes. The diode-lasers are spaced apart in a linear array with slow-axes thereof about collinear. An elongated cylindrical lens is arranged to collimate laser radiation emitted by the linear array of diode-lasers in the fast-axis thereof. A transmissive optical filter is located in the path of the collimated radiation from the linear array of diode-lasers. The optical filter has a peak transmission wavelength within the gain-bandwidth of the diode-lasers and has a bandwidth less than the gain-bandwidth of the diode-lasers. A corner reflector, including first and second elongated reflecting surfaces perpendicular to each other, is arranged to reflect radiation transmitted by the optical filter to the cylindrical lens after being re-transmitted through the optical filter. The cylindrical lens and the corner reflector are further configured and arranged such that at least a portion of the retransmitted radiation is focused in the fast-axis back into each of the diode-lasers in the array.

In one preferred embodiment of the inventive apparatus output radiation is emitted from one end of each diode-laser and the cylindrical lens, the optical filter, and the corner reflector operate on radiation from an opposite end of each diode-laser. In another preferred embodiment of the inventive apparatus the cylindrical lens, the optical filter, and the corner reflector operate on output radiation from the diode-laser and one of the reflecting surfaces of the corner reflector is made partially transmissive to deliver output radiation from the apparatus.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a front elevation view schematically illustrating a prior-art diode-laser bar with emitters thereof misaligned in the fast-axis direction of the diode-laser bar giving rise to the effect commonly referred to as “smile”.

FIG. 2 is a side-elevation view schematically illustrating the diode-laser bar of FIG. 1 cooperative with a cylindrical lens arranged to fast-axis collimate beams from the emitters of the diode laser bar, and with a plane-mirror arranged to reflect the collimated emitted beams back toward the diode-laser bar, and schematically illustrating how a beam from an emitter not precisely aligned with the optic axis of the lens can not be reflected back into the emitter by the mirror.

FIG. 3 is a side elevation view schematically illustrating an arrangement in accordance with the present invention, similar to the arrangement of FIG. 2, but wherein the mirror of FIG. 2 is replaced by a one-axis corner reflector that causes a beam from any emitter in the diode-laser bar to be reflected in the fast-axis back into that emitter essentially independent of the alignment of the emitter with the optic axis of the lens.

FIG. 4 is a fast-axis side-elevation view schematically illustrating one preferred embodiment of a wavelength-locked diode-laser bar apparatus in accordance with the present invention including a feedback resonator for emitters of the diode-laser bar having a cylindrical lens cooperative with a fast-axis corner reflector and the rear end of emitters of the diode-laser bar, with a wavelength selective element included in the resonator between the cylindrical lens and the corner reflector.

FIG. 5 is a fast-axis side-elevation view schematically illustrating another preferred embodiment of a wavelength-locked diode-laser bar apparatus in accordance with the present invention similar to the apparatus of FIG. 4 but further including an array of slow-axis collimating lenses having one lens for each emitter of the diode-laser bar and being located between the fast-axis collimating lens and the wavelength-selective element.

FIG. 6 is a three-dimensional view schematically illustrating further details of the apparatus of FIG. 5.

FIG. 7 is a fast-axis side-elevation view schematically illustrating yet another preferred embodiment of a wavelength-locked diode-laser bar apparatus in accordance with the present invention including a feedback resonator for emitters of the diode-laser bar having a cylindrical lens cooperative with a fast-axis corner reflector and the front or output end of emitters of the diode-laser bar, with a wavelength selective element included in the resonator between the cylindrical lens and the corner reflector.

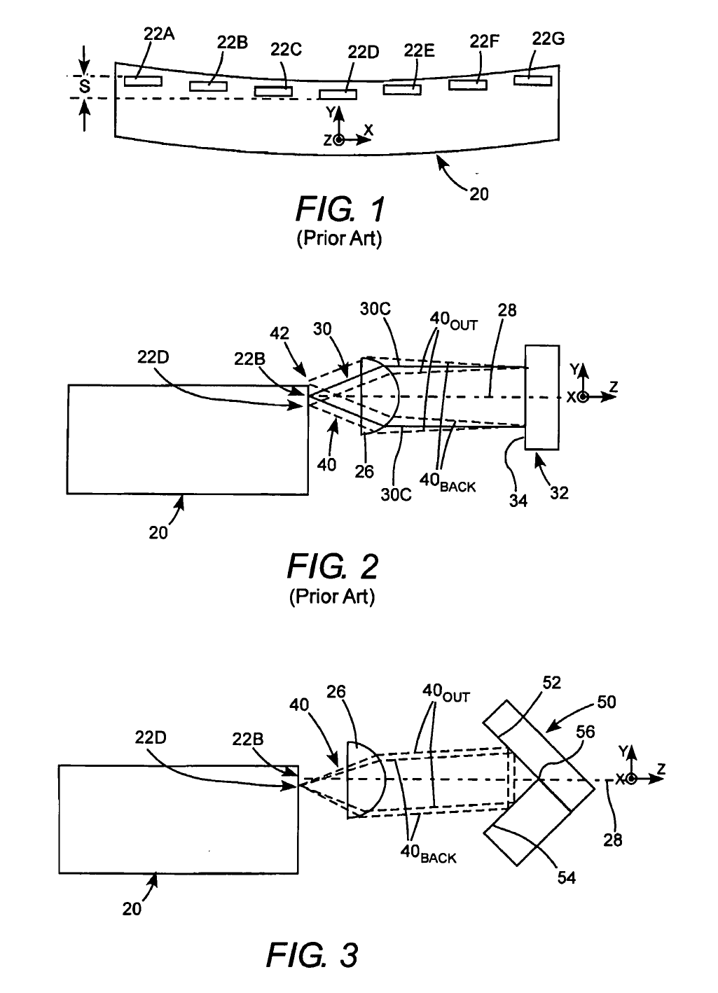

### DETAILED DESCRIPTION OF THE INVENTION

Referring again to the drawings, wherein like components are designated by like reference numerals, FIG. 3 schematically illustrates an important principle of an apparatus in accordance with the present invention for wavelength locking a diode-laser bar. The apparatus of FIG. 3 is similar to the apparatus of FIG. 2 with an exception that mirror 32 of FIG. 2 is replaced by a fast-axis corner reflector 50 including reflecting surfaces 52 and 54 arranged perpendicular to each other. In this example, the apex 56 of the corner reflector (the junction of the reflecting surfaces) is aligned on optic axis 28 of cylindrical lens 26, and reflecting surfaces 52 and 54 are inclined at respectively plus and minus 45° to optic axis 28. Axis 28 is also aligned with the Z-axis of emitter 22B (and 22F).

Those skilled in the art will recognize that the term “cylindrical lens” as used in this description and the appended claims means only that the lens has optical power in one transverse axis only. Usually such a lens has a plano-convex shape, however, a cylindrical lens with two curved surfaces may be used without departing from the spirit and scope of the present invention.

As far as the beam from emitter 22B (or 22F) is concerned, outbound rays will be incident at plus and minus 45° on reflecting surfaces of the corner reflector and, accordingly, will be reflected from the corner reflector such that the an incident ray at any particular distance above axis 28 will return to lens 26 along a path coinciding with the path of an incident ray is the same distance below axis 28, and vice-versa. The reflected collimated beam as a whole, now inverted, will be focused by lens 26 into emitter 22D as is the case in the prior-art plane mirror arrangement of FIG. 2. In effect there will be two beams circulating between the emitter and the corner reflector in opposite directions.

The emitter-22D beam is not depicted in FIG. 3 in order to be able to highlight what happens to beam 40 from the misaligned emitter 22B. Here, outbound beam 40 is collimated by lens 26 (rays 40_{OUT}) but propagates at an angle to axis 28 as discussed above for the arrangement of FIG. 2. Because the collimated beam 40_{OUT} is incident on the reflecting surfaces at some other angle than 45°, the reflected beam 40_{BACK} is laterally displaced in the fast axis direction but propagates parallel to the incident beam. This beam strikes cylindrical lens 26 in such a way that the beam is focused by the lens back into the emitter from which it was emitted. Provided an adequate clear aperture is selected for lens 26, this will be true for any emitter at any anticipated degree of misalignment, i.e., whatever the extent of smile in the diode-laser bar. Here again, there will effectively be two-beams propagating in opposite directions.

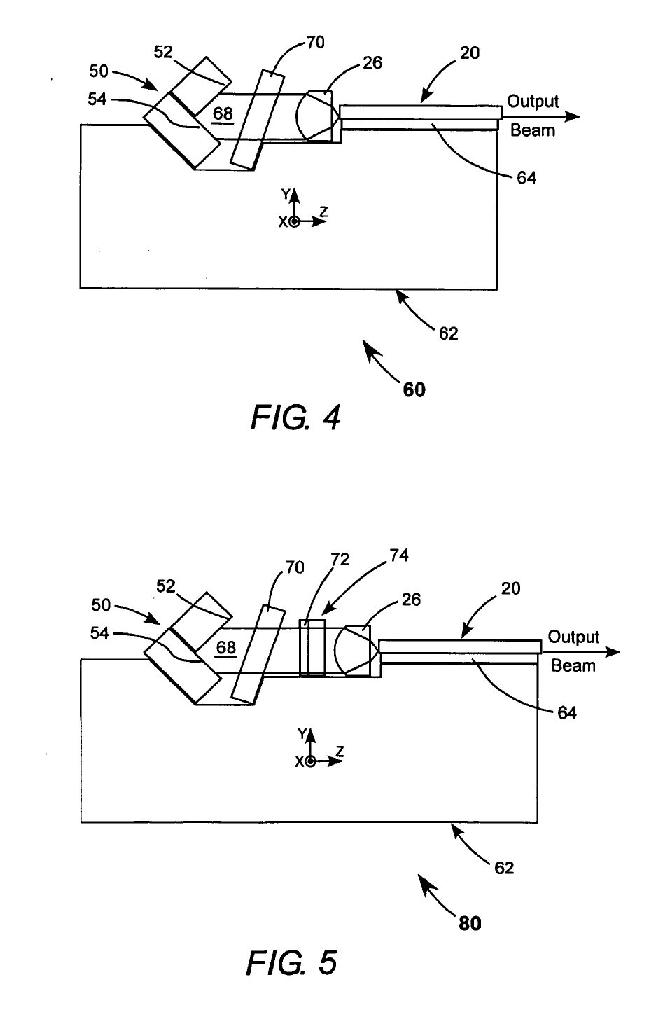

FIG. 4 is an elevation view schematically illustrating one preferred embodiment 60 of a wavelength locked diode-laser bar in accordance with the present invention. Here diode-laser bar 20 is supported on a heat sink 62, preferably via a heat spreader 64 of a highly thermally conductive dielectric material such a diamond, sapphire (Al₂O₃), aluminum nitride (AlN), or beryllium oxide (BeO). Other components are supported on precision machined (or etched) grooves and surfaces, evident in the drawing, but not numerically designated. In this example, the corner-reflector principle of FIG. 3, including corner reflector 50 with reflective surfaces 52 and 54 cooperative with cylindrical lens 26, is arranged to form an external feedback-resonator 68 cooperative with the rear facets of emitters of the diode-laser bar. No attempt is made to depict beams from individual emitters of the diode-laser bar in FIG. 4. This will be evident to those skilled in the art from the description provided above with reference to FIG. 3. A transmissive optical filter 70, such as a multilayer narrow band interference filter, is located between cylindrical lens 26 and corner reflector 50 in resonator 68 with surfaces of the corner reflector non-orthogonally inclined to collimated beams in the resonator. Filter 70 selects a narrow band of wavelengths from the gain-bandwidth of the emitters and locks the output of all emitters in the diode-laser bar to that band of wavelengths, as discussed above.

One suitable interference filter for filter 70 is a MaxLine™ Laser-Line Filter, available from manufactured by Semrock, Inc. of Rochester, N.Y. This filter is designed for 808 nm laser-diodes and has an FWHM bandwidth of about 3 nm and a peak-transmission sufficient to provide efficient feedback. In general, it is important that any filter used as filter 70 be relatively insensitive to temperature, and is mounted such that it is not significantly heated by the pump-current of the diode-laser bar.

As noted above, wavelength-locking resonator 68 in the embodiment of FIG. 4 is cooperative with emitters of the diode-laser bar via rear ends (facets) thereof. The actual output of diode-laser bar is at the end of the emitters opposite those included in the wavelength-locking resonator. The output (front) faces of the emitters are preferably coated with a partially reflecting and partially transmissive (PR) coating that is optimized for the efficiency of the emitters, as is known in the art. Rear faces of the emitters of external resonator can be coated either with anti-reflective (AR) coating, or PR coating. An AR coating provides maximum possible feedback to the laser. However, it may be found that less than 100% feedback is sufficient for locking the wavelength. In that case, a PR coating is preferred because this reduces the amount of power in the external resonator, and, accordingly, reduces optical losses in the external components, particularly the interference filter. An optimum reflectivity for a rear-face PR coating can readily be determined experimentally for a particular diode-laser bar and components of the wavelength-locking resonator.

The external components can be pre-aligned by placing them into the precision-machined (or etched) grooves in common heatsink 62 of the wavelength locked diode-laser bar assembly 60. Provided that components of corner reflector 50 is assembled separately with surfaces 52 and 54 being precisely at 90° to each other, the alignment of the corner reflector with beam with respect to the beam from any emitter of the bar, or with respect to optic axis 28 of lens 26, is not critical within the normal range of precision machining tolerances. The same is true for the nominal alignment angle of filter 70.

It should be noted, here, that the wavelength-locking arrangement of FIG. 4 is not optimum if feedback is from the external resonator is to be maximized. This is because measures are not taken to deal with beam divergence of the emitters in the slow-axis (X-axis) thereof. Because of this, while the corner reflector ensures that fast-axis rays are refocused into any emitter from which those rays originate, expansion of the beam in the slow axis will provide that less than 100% of the beam width returns to the emitter, whatever the efficiency of resonator components.

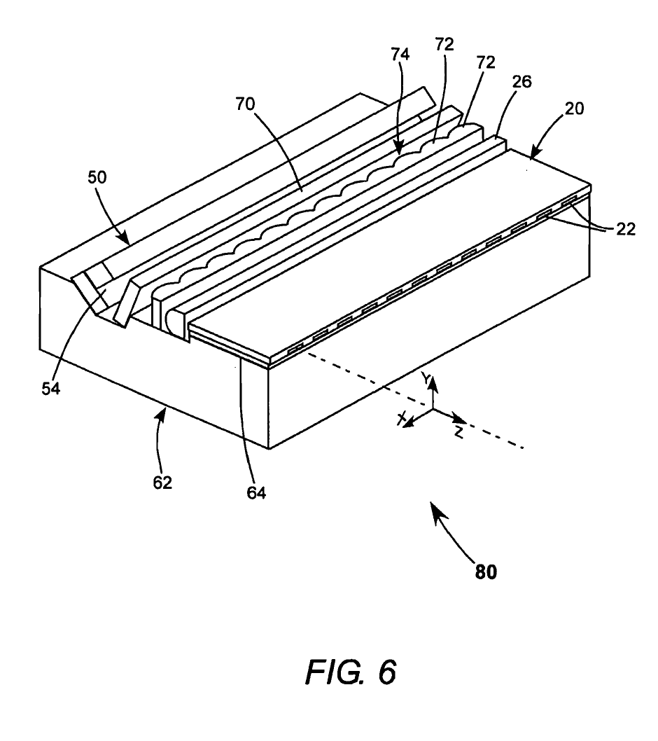

FIG. 5 and FIG. 6 schematically illustrate another preferred embodiment 80 of a wavelength locked diode-laser bar in accordance with the present invention. This embodiment is similar to the embodiment of FIG. 4 but further includes an array of slow-axis collimating lenses 72, here in a monolithic array 74 thereof, with one such lens for each emitter in the diode-laser bar. In the three-dimensional view of FIG. 6, it is assumed that there 12 emitters 22, equally spaced, in the bar. This is an arbitrary number of emitters, and, as such, should not be construed as limiting the invention to any number of emitters per bar. The slow-axis collimating lenses provide that whatever the slow-axis dimension of an incident beam at the point where the beam is intercepted by corner reflector 50, the reflected beam will be refocused to about the slow axis dimension of the emitter as the beam re-enters the emitter.

One disadvantage of preferred embodiments 60 and 80 is that diode-laser bar 20 must to be precision aligned with respect to heatspreader 64. This is in order to not damage the emitting surfaces of the diode-laser bar during a soldering process by which the diode-laser bar is bonded to the heat spreader, and in order not to leave areas of the diode-laser bar that are not in thermal communication with the heat-sink. Preferably, the edge of the diode-laser bar should overhang the heat-sink by about 5 μm. This means that heat-spreader 64 must be manufactured to very tight tolerances, and perhaps even individually fitted to the bar width.

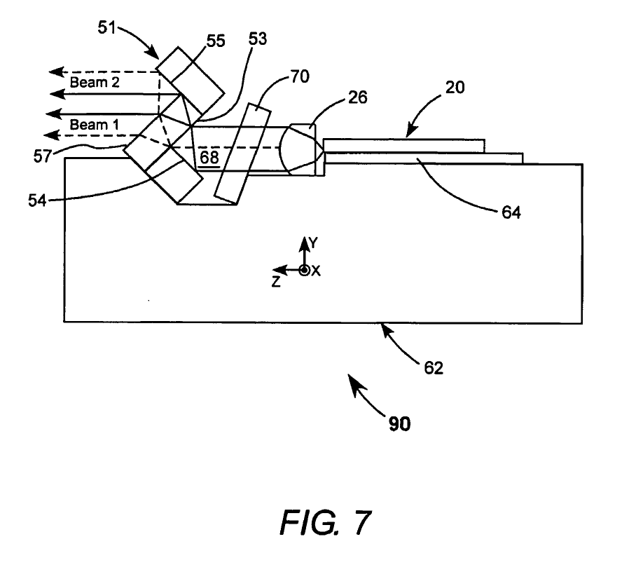

FIG. 7 schematically illustrates yet another embodiment 90 of a wavelength-locked diode-laser bar in accordance with the present invention in which this disadvantage is not present. Here, output of diode laser bar 20 is from the side of the diode-laser bar on which the wavelength-locking external resonator 68 is located, which can be accordingly be considered the front of the diode-laser bar. A highly reflective (HR) coating preferably with reflectivity maximized for the peak transmission of the optical filter, is deposited on rear faces of the emitters of the diode-laser bar and the diode-bar mounting procedure is comparable with existing manufacturing techniques. However, since effectively two waves (beams) circulate in the external resonator in opposite directions as noted above, two outputs (Beam 1 and Beam 2) are possible.

Taking this into account, corner reflector 50 of above-described embodiments is replaced in embodiment 90 by a corner reflector 51 that has a highly reflective (HR) surface 54 at 90° to a partially reflecting and partially transmissive (at the peak wavelength of the optical filter) surface 53. Surfaces 54 and 53 face into the resonator. A surface 57 opposite surface 53 is AR coated for about the locked-wavelength, and is parallel to surface 53. Another reflective surface 55 is provided at 90° to surface 57 and preferably has a reflectivity that is maximized for the peak wavelength of the optical filter. The purpose of this surface is to direct the second output (Beam 2) parallel to the first output (Beam 1). Again, this can be achieved by assembling the components providing the three reflective surfaces of the corner reflector separately, to ensure that the surfaces are precisely orthogonal to each other.

Each of the output beams is depicted as being bounded by a solid line and a dashed line. The beams propagate side-by-side, parallel to each other, and eventually, overlap in the far field. This is perfectly suitable for laser pumping and other applications wherein only the far-field intensity distribution of radiation in a beam is important, or wherein near-field intensity distribution is not important at all. An additional benefit of embodiment 90 is that the output beam is collimated by cylindrical lens 26 of wavelength-locking feedback resonator 68. In the embodiments of FIG. 4 and FIG. 5, additional fast-axis or slow-axis collimating lenses are required if the output of the diode laser bar is to be collimated in one or both transverse axes.

Regarding precision optical assembly of corner reflectors 50 or 51, one possible method of manufacturing the corner reflector is to make it from a layer or sheet of a single crystal material such as a silicon wafer. An industry standard silicon wafer having a thickness of between about 0.6 and 1.2 mm can be coated with the desired AR, PR or HR coating and then cleaved into slabs of required size for the corner reflector components. With a proper crystallographic orientation of the wafer, for example <100>, cleavage planes of the wafer are exactly perpendicular to the surface of the wafer and to each other, surfaces of the wafer are precisely parallel to each other. Because of this, two or three cleaved silicon slabs can be assembled by optical contact, or by cementing with an appropriate bonding agent such as an epoxy to form a corner reflector assembly 50 as depicted in FIG. 4. As one silicon wafer may yield thousands of cleaved slabs, such process is quite inexpensive.

In the case of a corner reflector 51 which has a transmission function in addition to a reflection function, crystal quartz, sapphire or other transparent crystal materials can be used instead of silicon. The use of optical glass or fused silica for forming components of the corner reflector is not precluded, however such materials must be cut into a slabs using a conventional diamond saw, common in the semiconductor industry.

In above described embodiments of the present invention, an interference filter is described as a preferred wavelength-selective optical element. Those skilled in the art, however, may devise embodiments of the present invention including other wavelength selective elements without departing from the spirit and scope of the present invention. Such elements include birefringent filters, etalons, and volumetric gratings. Many of these elements have been developed for telecommunications and accordingly are usually relatively inexpensive, robust, and reliable.

In summary present invention is described above in terms of a preferred and other embodiments. The invention is not limited, however, to the embodiments described and depicted. Rather, the invention is limited only by the claims appended hereto.

What is claimed is:

1. Optical apparatus comprising:
a plurality of diode-lasers each thereof having a gain bandwidth, a fast-axis, and a slow-axis and being arranged to emit laser radiation generally along a propagation-axis perpendicular to the fast- and slow-axes, the diode-lasers being spaced apart in a linear array with slow-axes thereof about collinear;
an elongated cylindrical lens arranged to collimate laser radiation emitted by the linear array of diode-lasers in the fast-axis thereof;
an optical filter located in the path of the collimated radiation from the linear array of diode-lasers, the optical filter having a peak transmission wavelength within the gain-bandwidth of the diode-lasers and having a bandwidth less than the gain-bandwidth of the diode-lasers; and
a corner reflector including first and second elongated reflecting surfaces perpendicular to each other, the corner reflector arranged to reflect radiation transmitted by the optical filter to the cylindrical lens after being re-transmitted through the optical filter, the cylindrical lens and the corner reflector being further configured and arranged such that at least a portion of the retransmitted radiation is focused in the fast-axis back into each of the diode-lasers in the array.

2. The apparatus of claim 1, wherein the optical filter is one of a multilayer interference filter, an etalon, a birefringent filter, and a volumetric grating.

3. The apparatus of claim 1, wherein the optical filter is a multilayer interference filter.

4. The apparatus of claim 1, wherein the cylindrical lens has an optic axis arranged parallel to the propagation-axis of radiation emitted by the diode-lasers.

5. The apparatus of claim 4, wherein the first and second reflecting surfaces of the corner reflector are inclined respectively at about plus and minus forty-five degrees to the optic axis of the cylindrical lens.

6. The apparatus of claim 5, wherein the first and second reflecting surfaces of the corner reflector are in contact with each other to form an apex of the corner reflector and the apex of the corner reflector is aligned on the optic axis of the cylindrical lens.

7. The apparatus of claim 1, wherein the diode-lasers are arranged such that radiation therefrom collimated by the cylindrical lens is emitted from a first end of each of the diode-lasers and output-radiation is emitted from an opposite second end of the diode-lasers.

8. The apparatus of claim 7, wherein the reflectivity of the reflecting surfaces of the corner reflector is maximized for a wavelength about equal to the peak transmission wavelength of the optical filter.

9. The apparatus of claim 1, wherein the diode-lasers are arranged such that radiation therefrom collimated by the cylindrical lens is output radiation and the radiation that is focused back into each of the diode-lasers by the cylindrical lens is a portion of that output radiation.

10. The apparatus of claim 9, wherein the first reflecting surface of the corner reflector has a reflectivity that is maximized for a wavelength about equal to the peak transmission wavelength of the optical filter, and the second reflecting surface is selected such that a first portion of the radiation incident thereon is transmitted by the corner reflector and a second portion of the radiation incident thereon is reflected by the corner reflector.

11. The apparatus of claim 10, wherein radiation circulates between the each of the diode-lasers and the corner reflector in two waves traveling in opposite directions and the portion of the circulating radiation transmitted by the second reflecting surface of the corner reflector is transmitted as first and second output beams for each diode-laser corresponding to the opposite directions of circulation.

12. The apparatus of claim 11, further including a third reflecting surface arranged to intercept the second output beams of the diode-lasers and reflect the second output beams in a direction parallel to the first output beams of the diode-lasers.

13. The apparatus of claim 12, wherein the third reflecting surface reflector is orthogonal to the first and second reflecting surfaces of the corner reflector.

14. The apparatus of claim 1, wherein the first and second reflecting surfaces of the corner reflector are first surfaces of first and second opposite surfaces of first and second optical components cleaved from a single-crystal sheet, with edges of the optical components being perpendicular to the first and second opposite surfaces thereof.

15. The apparatus of claim 14, wherein the single-crystal sheet is a sheet of one of silicon, silica, or alumina.

16. The apparatus of claim 1, further including an plurality of cylindrical lenses located between the fast-axis collimating cylindrical lens and the optical filter with each lens arranged to collimate radiation emitted from a corresponding one of the diode-lasers in the slow axis thereof.

17. The apparatus of claim 16, wherein the plurality of slow-axis collimating cylindrical lenses is arranged in a monolithic array thereof.

18. A frequency stabilized diode laser array comprising:
a linear array of laser diodes, each diode having an emitter generating an output beam;
a cylindrical lens aligned with the emitters for collimating the output beams;
a feedback mirror arrangement including a pair of orthogonally oriented reflecting surfaces, with the vertex of the surfaces being aligned with the central axis of the lens and functioning to return at least a portion of the output beams back into the respective emitters; and
an optical filter located between the lens and mirror arrangement and having a narrow transmission bandwidth within the gain bandwidth of the emitters so that narrow bandwidth light is returned to emitters whereby the output of the emitters will be frequency locked.

19. The array of claim 1, wherein the optical filter is a multilayer interference filter.

20. The array of claim 1, wherein the emitters define the back of the laser diodes and the output from the array is emitted from the opposed front side of the diodes.

21. The array of claim 1, wherein the mirror arrangement is only partially reflected with the portion of the light being transmitted defining the output of the array.
